(19) United States
(12) Patent Application Publication
(10) Pub. No.: US 2016/0322879 A1
(43) Pub. Date: Nov. 3, 2016

(54) STATOR HAVING VARNISH SUPPLY PASSAGE AND MOTOR

(71) Applicant: FANUC CORPORATION, Yamanashi (JP)

(72) Inventor: Shinichi Kinoshita, Yamanashi (JP)

(73) Assignee: FANUC CORPORATION, Yamanashi (JP)

(21) Appl. No.: 15/078,083

(22) Filed: Mar. 23, 2016

(30) Foreign Application Priority Data
Apr. 30, 2015 (JP) 2015-093581

(51) Int. Cl. H02K 3/32

(52) U.S. Cl. CPC H02K 3/32

(57) ABSTRACT

A plurality of stator tooth portions is formed on an inner peripheral portion of a stator. Recesses are formed to extend from the tip ends of the stator tooth portions toward the base portions thereof. Coils are exposed in the recesses.

### BACKGROUND OF THE INVENTION

1. Field of the Invention

The present invention relates to a stator in which coils wound around tooth portions of the stator are impregnated with varnish and a motor having such a stator.

2. Description of the Related Art

In general, a rotating motor is provided with a rotor which rotates about a central axis and a cylindrical stator which applies a magnetic rotating force to the rotor. The stator is provided, on its inner peripheral surface, with a plurality of tooth portions which project toward the central axis and which are successively arranged in the circumferential direction of the stator. Each of the tooth portions extends longitudinally in the axial direction of the stator. A wire (conductor) is wound around each tooth portion. Such a tooth portion is referred to as “a stator tooth portion” or “a stator core”. Furthermore, all wires wound around tooth portions are referred to as “a coil” and a wound wire is referred to as “a winding”.

In such a rotating motor, in order to improve the insulation properties, heat resistivity and strength of the stator, conventionally, varnish is dropped onto the coils wound around the stator tooth portions to impregnate the portions between the windings with the varnish.

For example, Japanese Patent Publication No. 2006-6054 discloses a method for spreading varnish over the coils by dropping the varnish onto the coil ends located in the vicinity of both ends of the stator tooth portions in the longitudinal direction (which will be referred to simply as “both ends of the stator tooth portions”).

Japanese Patent Publication No. H06-327203 discloses a method for impregnating the coil ends in the vicinity of both ends of the stator tooth portions as well as the central portions of the stator tooth portions with varnish when the varnish is dropped onto the coils.

Note that, the term “coil ends” refers to the portions of the coils wound around the stator tooth portions that protrude outwardly from both ends of the stator tooth portions. In the varnish dropping method disclosed in Japanese Patent Publication No. 2006-6054, the longer the overall length of the stator, the less the varnish spreads over the coil portions located in the intermediate portions between both ends of the stator tooth portions. As a result, there is a problem that stators whose coils have failed to be sufficiently impregnated with varnish may be produced.

This problem will be discussed below with reference to the drawings. FIG. 5A is a schematic sectional view of a stator according to the prior art mentioned above in which the coils are impregnated with varnish which is dropped thereon. FIG. 5B is a sectional view of the stator taken along the line A-A in FIG. 5A.

As can be seen in these drawings, the cylindrical stator 100 is provided, on its inner peripheral surface, with a plurality of stator tooth portions 101 which are formed successively in the circumferential direction of the stator 100. Each of the stator tooth portions 101 is in the form of a projection that protrudes from the inner peripheral surface of the stator 100 toward a hollow portion 100a and that is elongated along the axial direction of the stator 100. A coil 102 is wound around each of the stator tooth portions 101.

With reference to FIG. 5A, housings 103 and 104 are attached to both ends of the stator 100 in the direction of the central axis X. When varnish is dropped onto the coils 102, the stator 100 is placed so that the central axis X extends in the horizontal direction and the stator 100 is supported so as to rotate about the central axis X. As may be seen in FIG. 5A, two nozzles 105 are inserted into the hollow portion 100a of the stator 100 through the openings of the housings 103 and 104, and thereafter, varnish is dropped onto the coils 102 from the nozzles 105. While the varnish is dropped, the stator 100 is rotated about the central axis X. The varnish is dropped onto the coil ends 102a that are located at both ends of the stator tooth portions 101. However, it becomes more difficult for the varnish to reach the coil portions (portions indicated by P in FIG. 5A) that are located between both ends of the stator 100 in the axial direction from each coil end 102a as the total length of the stator 100 in the direction of the central axis X thereof increases.

Furthermore, in the varnish dropping method disclosed in Japanese Patent Publication No. H06-327203, the following problems occur. Namely, in this method, varnish is dropped onto the tip ends 101a of the stator tooth portions 101 that face the hollow portion 100a of the stator 100 as shown in FIG. 5A. In this case, the path along which the dropped varnish reaches the coils 102 is provided only by the path extending from the tip ends 101a of the stator tooth portions 101 toward the gaps S between the adjacent stator tooth portions 101. However, as the gaps S between the adjacent stator tooth portions 101 are very narrow as can be seen in FIG. 5B, the varnish tends not to enter the gaps S. Moreover, as the amount of varnish entering the gaps S between the adjacent stator tooth portions 101 is small, it is difficult for the varnish to reach the coil portions that are located in the deep portions of the gaps between the adjacent stator tooth portions 101. Therefore, in the varnish dropping method disclosed in Japanese Patent Publication No. H06-327203, there is a problem that stators whose coils have failed to be sufficiently impregnated with varnish may be produced.

Furthermore, if a larger amount of varnish is dropped onto the coils, in order to eliminate the aforementioned drawbacks that the varnish dropping methods described in Japanese Patent Publication No. 2006-6054 and Japanese Patent Publication No. H06-327203 have, additional problems that the time necessary to impregnate the coils with the varnish and the amount of varnish to be used increase, occur. Moreover, an excess amount of varnish flows out to the outside of the stator, so that the surrounding portion of the stator may be contaminated thereby.

### SUMMARY OF THE INVENTION

The present invention provides a stator which is configured to sufficiently impregnate the coils with varnish and a motor having the stator.

According to the first aspect of the present invention, there is provided a stator for a motor comprising a first side and a second side opposite the first side, wherein the stator comprises a plurality of tooth portions arranged on the first side, and coils wound around the tooth portions, the stator is provided with at least one varnish supply passage formed therein to supply varnish to the coils through the inside of the tooth portions.

According to the second aspect of the present invention, in the stator according to the first aspect, the varnish supply passage is formed by recesses formed to extend from tip ends of the tooth portions toward base portions thereof, so that the coils are exposed in the recesses.

According to the third aspect of the present invention, in the stator according to the first aspect, the varnish supply passage is formed of a recess formed in the second side, so that the coils are exposed in the recess.

According to the fourth aspect of the present invention, in the stator according to the second or third aspect, the recesses are located in intermediate portions between both ends of the tooth portions in the longitudinal direction.

According to the fifth aspect of the present invention, in the stator according to the first aspect, the varnish supply passage comprises a recess formed on either the first side or the second side, and communication holes in which the varnish passes, connected to the recess and extending through the tooth portions, both ends of the communication holes are located in proximity to the coils.

According to the sixth aspect of the present invention, in the stator according to the fifth aspect, the recess and the communication holes are located in intermediate portions between both ends of the tooth portions in the longitudinal direction.

According to the seventh aspect of the present invention, in the stator according to any one of the first to sixth aspects, the stator is cylindrical, the first side is defined by the inner peripheral portion or outer peripheral portion of the cylindrical stator, and the plurality of tooth portions are successively provided in the circumferential direction of the cylindrical stator.

According to the eighth aspect of the present invention, there is provided a motor comprising the stator according to any one of the first to seventh aspects.

The aforementioned objects, features and advantages and other objects, features and advantages of the present invention will become more apparent from the detailed description of the representative embodiments of the present invention illustrated in the accompanying drawings.

### BRIEF DESCRIPTION OF THE DRAWINGS

FIG. 1A is a schematic sectional view of a stator according to the first embodiment of the present invention in which varnish is dropped onto a coil to impregnate the same with the varnish.

FIG. 1B is a sectional view of the stator taken along the line B-B in FIG. 1A.

FIG. 1C is a partial schematic view of the inner peripheral portion of the stator shown in FIG. 1B.

FIG. 2 is a schematic sectional view of a motor to which the present invention is applied, by way of example.

FIG. 3A is a schematic sectional view of a stator according to the second embodiment of the present invention in which varnish is dropped onto a coil to impregnate the same with the varnish.

FIG. 3B is a sectional view of the stator taken along the line C-C in FIG. 3A.

FIG. 3C is a partial schematic view of the inner peripheral portion of the stator shown in FIG. 3B.

FIG. 4A is a schematic sectional view of a stator according to the third embodiment of the present invention in which varnish is dropped onto a coil to impregnate the same with the varnish.

FIG. 4B is a sectional view of the stator taken along the line D-D in FIG. 4A.

FIG. 4C is a partial schematic view of the inner peripheral portion of the stator shown in FIG. 4B.

FIG. 5A is a schematic sectional view of a conventional stator in which varnish is dropped onto a coil to impregnate the same with the varnish.

FIG. 5B is a sectional view of the stator taken along the line A-A in FIG. 5A.

### DETAILED DESCRIPTION OF THE INVENTION

The embodiments of the present invention will be described below with reference to the drawings. In the drawings, the same reference numerals are assigned to the same or corresponding components. For the sake of easy understanding, the scale of the drawings was appropriately changed. Moreover, the following embodiments are applied to a stator for a rotating motor by way of example, but the present invention is not limited thereto.

### First Embodiment

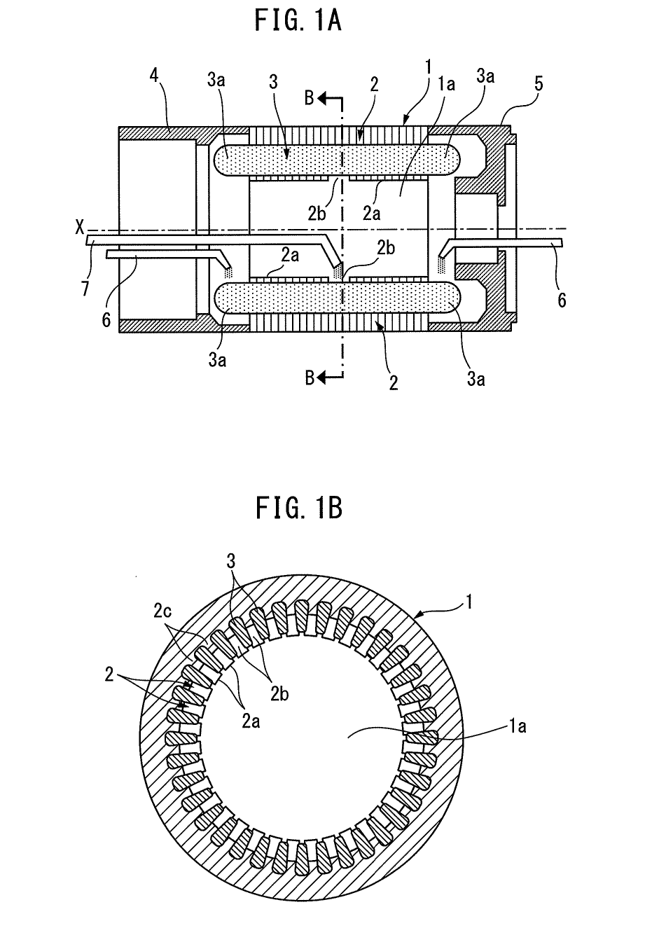

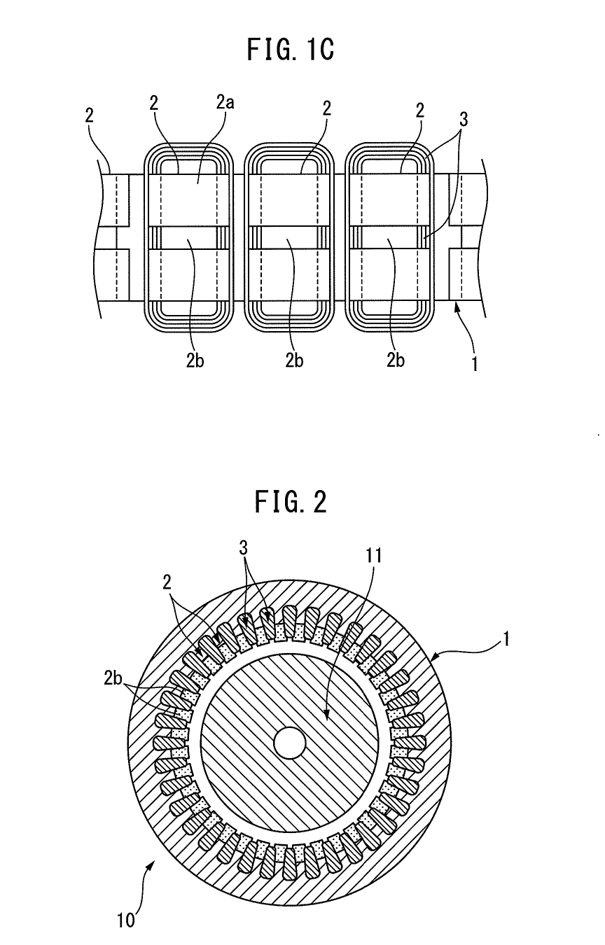

FIG. 1A is a schematic sectional view of a stator according to the first embodiment of the present invention to show a method for impregnating the coil with varnish which is dropped thereon. FIG. 1B is a sectional view of the stator taken along the line B-B in FIG. 1A. FIG. 1C schematically illustrates a part of the inner peripheral portion of the stator shown in FIG. 1B.

With reference to FIGS. 1A to 1C, the stator 1 of the first embodiment comprises a stator tooth portions 2 and coils 3 wound around the stator tooth portions 2. The stator 1 is provided, on its opposite ends in the direction of the central axis X, with housings 4 and 5 attached to the ends as can be seen in FIG. 1A. The stator 1 is made of a plurality of electromagnetic steel plates which are laminated in the direction of the central axis X.

Specifically, as can be seen in FIG. 1A, the cylindrical stator 1 is provided, on its inner peripheral surface, with a plurality of stator tooth portions 2. Each of the elongated stator tooth portions 2 is in the form of a projection which extends from the inner peripheral surface of the stator 1 toward the hollow portion 1a. Furthermore, each stator tooth portion 2 is elongated in the direction of the central axis X of the stator 1. As shown in FIG. 1B, the plurality of stator tooth portions 2 are successively arranged at predetermined distances in the circumferential direction of the stator 1. A coil 3 is wound around each of the stator tooth portions 2 as shown in FIG. 1C. Note that the coils 3 are impregnated with varnish to enhance the insulation properties, heat resistance, and strength of the stator 1, as will be described hereinafter.

Furthermore, in the present invention, as can be seen in FIGS. 1A to 1C, the tip ends 2a of the stator tooth portions 2 are each provided with a recess 2b. The “tip ends 2a of the stator tooth portions 2” refer to the front end surfaces of the stator tooth portions 2 that face the hollow portion 1a of the stator 1.

The recesses 2b are located in the intermediate portions between both ends of the stator tooth portions 2 in the direction of the central axis X. The recesses 2b are formed radially outwardly from the inner periphery of the stator 1 as shown in FIG. 1B. Namely, the recesses 2b are recessed toward the base portion 2c of the stator tooth portions 2 from the tip ends 2a of the stator tooth portions 2. In particular, the recesses 2b are formed so that the coils 3 are exposed in the recesses 2b, as can be seen in FIG. 1C. Consequently, when varnish is dropped into the recesses 2b at the tip ends 2a of the stator tooth portions 2 as shown in FIG. 2A, the varnish can be directly supplied to the coils 3 through the inside of the stator tooth portions 2. Namely, the recesses 2b define varnish supply passages.

The method for impregnating the coils 3 of the stator 1 according to the first embodiment with varnish will be described below.

As shown in FIG. 1A, the stator 1 is placed so that the central axis X of the stator 1 extends in the horizontal direction and the stator 1 is supported so as to rotate about the central axis X. Two nozzles 6 are inserted in the hollow portion 1a of the stator 1 through the openings of the housings 4 and 5 so as to drop the varnish onto the coil ends 3a that are located at both ends of the stator tooth portions 2. Furthermore, in order to drop the varnish into the recesses 2b of the tip ends 2a of the stator tooth portions 2, an additional nozzle 7 is arranged in the hollow portion 1a of the stator 1. Varnish is dropped from the two nozzles 6 and the additional nozzle 7. While the varnish is dropped in this way, the stator 1 is rotated about the axis X.

The varnish dropped onto the coil ends 3a moves therefrom to the coil portions that are located in the intermediate portions between the opposite ends of the stator tooth portions 2 due to a capillary force between the adjacent windings of the coil 3. Furthermore, the varnish dropped into the recesses 2b is maintained in the recesses 2b so that the coil portions which are exposed in the recesses 2b are directly impregnated with the varnish. That is, the varnish can be supplied to the coil portions other than the coil ends 3a directly without being impeded by the tip ends 2a of the stator tooth portions 2. Thus, even if the total length of the stator 1 in the direction of the central axis X is long, it is possible to sufficiently impregnate the entirety of the coils 3 with varnish. In particular, as shown in FIG. 1A, the recesses 2b are located in the intermediate portions between the opposite ends of the stator tooth portions 2 in the axial direction. As a result of this, when varnish is dropped onto the coil ends 3a and into the recesses 2b, it is possible to uniformly and effectively impregnate the coils 3 with the varnish in the direction of the central axis X of the stator 1.

Moreover, the recesses 2b are recessed toward the base portions 2c of the stator tooth portions 2 from the tip ends 2a of the stator tooth portions 2. Therefore, the varnish in the recesses 2b can easily reach the coil portions located in the vicinity of the base portions 2c of the stator tooth portions 2.

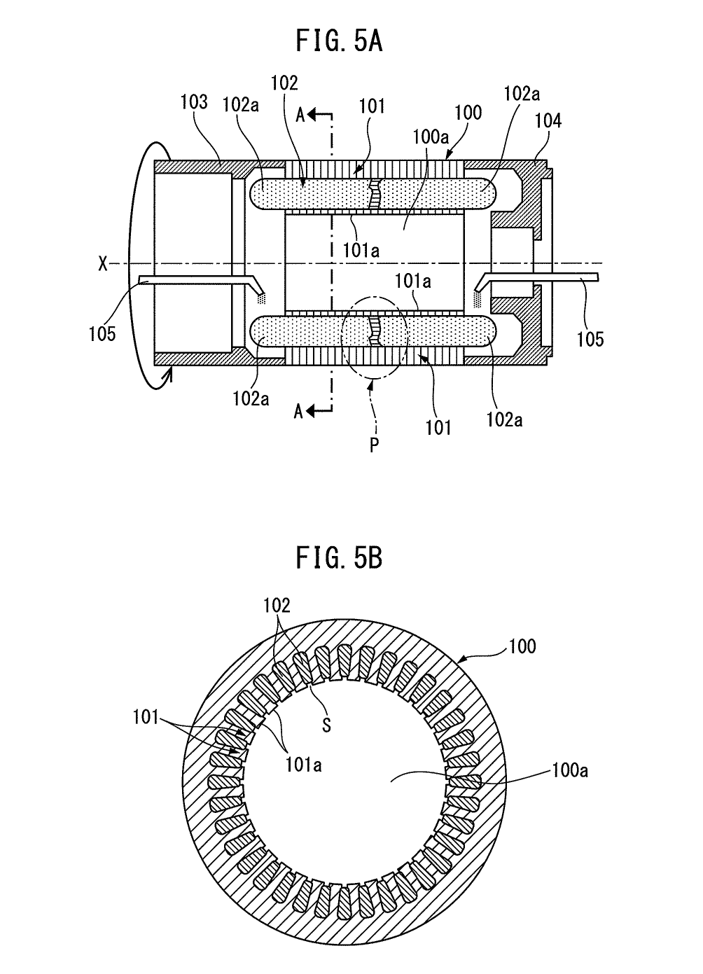

As may be understood from the foregoing, according to the first embodiment, the rate of occurrence of the stators 1 whose coils 3 have failed to be sufficiently impregnated with the varnish can be reduced compared with the prior art shown in FIGS. 5A and 5B. Furthermore, the time necessary to impregnate the coils 3 with the varnish and the amount of varnish to be used can be reduced compared with the prior art. Consequently, the productivity of the motors can be improved.

Note that the recesses 2b may be formed in portions other than the intermediate portions between the opposite ends of the stator tooth portions 2. Namely, a plurality of recesses 2b may be formed at extreme ends 2a of the stator tooth portions 2.

In the first embodiment, as shown in FIG. 1B, the plurality of recesses 2b are successively arranged over the entire inner periphery of the stator 1 and are located at the same position in the central axial direction of the stator 1. However, the present invention is not limited thereto. For instance, at least one recess 2b may be offset in the central axial direction with respect to the remaining recesses 2b at a part or a plurality of portions of the entire inner periphery of the stator 1.

The depth of the recesses 2b may be not necessarily identical in all the stator tooth portions 2. Moreover, the inner size of the recesses 2b may be appropriately modified.

Next, a motor having the stator 1 according to the first embodiment will be described below.

FIG. 2 is a schematic sectional view of a motor to which the present invention is applied by way of example. In particular, FIG. 2 is a sectional view of a motor corresponding to FIG. 1A which is a section taken along the line B-B.

The motor 10 is a rotating motor which comprises a rotor 11 which rotates about the central axis and a cylindrical stator 1 which provides a magnetic rotational force to the rotor 11. In the motor 10 illustrated in FIG. 2, the coils 3 around the stator tooth portions 2 have been impregnated with varnish supplied in the recesses 2b.

Note that the rotating motor to which the present invention is applicable is not limited to the embodiment illustrated in FIGS. 1A to 1C. For example, the rotating motor may be one comprised of an annular rotor and a stator arranged in the hollow portion of the rotor, wherein the stator is provided on its outer periphery, with a plurality of tooth portions which are arranged successively in the circumferential direction.

Furthermore, although FIG. 2 illustrates a rotating motor by way of example, a motor to which the stator of the present invention can be applied is not limited thereto. The stator of the present invention can be applied to a linear motor. For instance, if coils are wound around stator tooth portions of a linear motor, it is preferable that recesses 2b be formed in the tip ends 2a of the stator tooth portions 2 so that the coils 3 are exposed as shown in FIG. 1C.

### Second Embodiment

The second embodiment will be described below. The same components as those in the first embodiment are assigned the same reference numerals and no explanation thereof will be given hereinafter. In particular, only the difference from the first embodiment will be described.

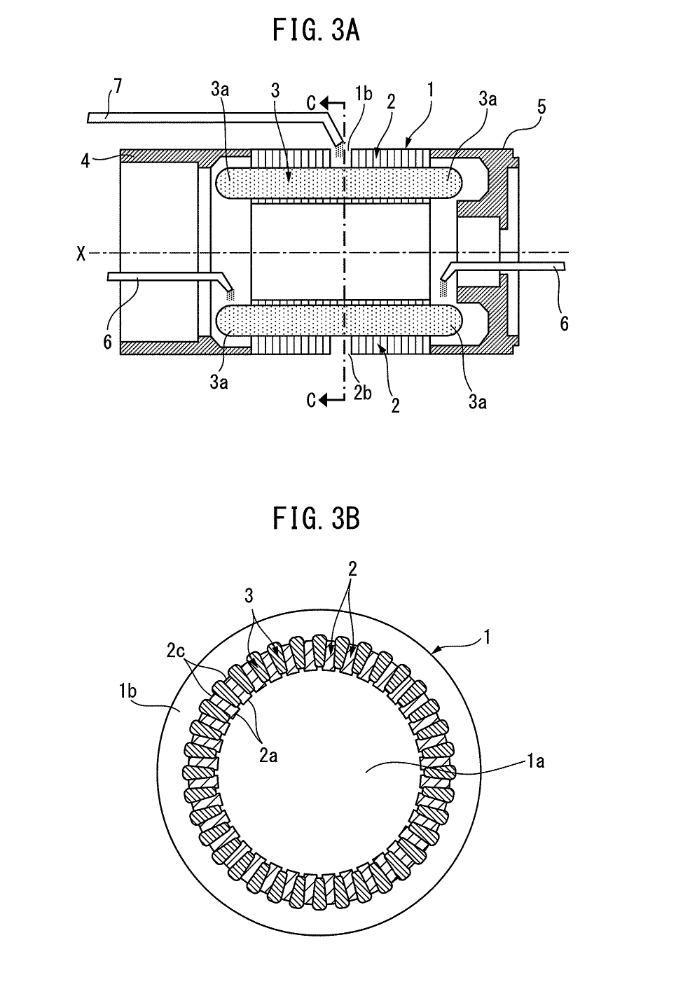

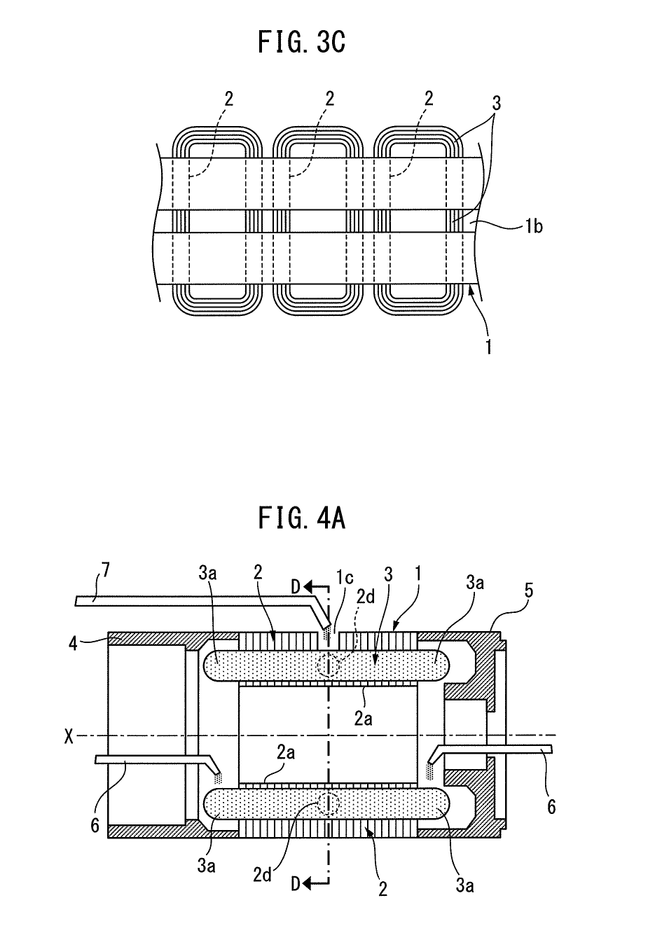

FIG. 3A is a schematic sectional view of a stator according to the second embodiment to illustrate how the coils are impregnated with varnish which is dropped thereon. FIG. 3B is a sectional view of a stator taken along the line C-C in FIG. 3A and FIG. 3C is a schematic view of a part of the outer peripheral portion of the stator shown in FIG. 3B.

In the second embodiment, a groove-shaped recess 1b is formed in the outer periphery of the stator 1, as can be seen in FIGS. 3A to 3C. The recess 1b is positioned corresponding to an intermediate portion between both ends of the stator tooth portions 2 in the direction of the central axis X, as shown in FIG. 3A. Moreover, the recess 1b is recessed from the outer periphery of the stator 1 in the radial inward direction of the stator 1, as shown in FIG. 3B. In particular, the recess 1b is formed so that the coil portions on the outer peripheral side of the stator 1 are exposed in the recess 1b, as can be seen in FIG. 3C. Consequently, as shown in FIG. 3A, it is possible to impregnate the coils 3 with varnish through the inside of the stator tooth portions 2 by directly dropping the varnish into the recess 1b formed in the outer periphery of the stator 1. Namely, the recess 1b defines a varnish supply passage. The remaining structures are identical to those of the first embodiment.

Next, the method for impregnating the coils 3 of the stator 1 according to the second embodiment with varnish will be described below.

As shown in FIG. 3A, the stator 1 is placed so that the central axis X of the stator 1 extends in the horizontal direction and the stator 1 is supported so as to rotate about the central axis X. Tow nozzles 6 are inserted in the hollow portion 1a of the stator 1 through the openings of the housings 4 and 5 so as to drop varnish onto the coil ends 3a located at both ends of the stator tooth portions 2. Furthermore, an additional nozzle 7 is arranged outside of the stator 1 so as to drop varnish into the recess 1b formed in the outer periphery of the stator 1. Varnish is dropped from the two nozzles 6 and the additional nozzle 7. Note that while the varnish is dropped, the stator 1 is rotated about the central axis X.

The varnish dropped onto each coil end 3a moves therefrom to the coil portions that are located at the intermediate portions between the opposite ends of the stator tooth portions 2 due to a capillary force produced between the adjacent windings of the coils 3.

Furthermore, the varnish dropped into the recess 1b is maintained in the recess 1b so that the coil portions which are exposed in the recess 1b are directly impregnated with the varnish. That is, the varnish can be supplied directly to the coil portions other than the coil ends 3a. Thus, even if the total length of the stator 1 in the direction of the central axis X is long, it is possible to sufficiently impregnate the entirety of the coils 3 with varnish. In particular, as shown in FIG. 3A, the recess 1b is located in the intermediate portions between the opposite ends of the stator tooth portions 2 in the direction of the central axis X. As a result of this, when varnish is dropped onto the coil ends 3a and into the recess 1b, it is possible to uniformly and effectively impregnate the coils 3 with the varnish in the direction of the central axis X of the stator 1.

As may be understood from the foregoing, according to the second embodiment, the rate of occurrence of the stators 1 whose coils 3 have failed to be sufficiently impregnated with the varnish can be reduced compared with the prior art shown in FIGS. 5A and 5B. Furthermore, the time necessary to impregnate the coils 3 with the varnish and the amount of varnish to be used can be reduced compared with the prior art. Consequently, the productivity of the motors can be improved.

Moreover, according to the second embodiment, as the recess 1b is formed in the outer peripheral portion of the stator 1, there is an advantage that it is not necessary for the two nozzles 6 and the additional nozzle 7 for dropping varnish to be concentrated in the hollow portion 1a of the stator 1, compared with the first embodiment. Namely, the present invention can be applied to a small-sized stator 1.

Note that an additional recess(es) 1b may be formed in portions other than the intermediate portions between the opposite ends of the stator tooth portions 2. Namely, a plurality of recesses 1b may be formed in the outer peripheral portion of the stator 1.

In the second embodiment, as shown in FIG. 3B, the groove-shaped recess 1b is formed to extend over the entire outer periphery of the stator 1 and is located at the same position in the central axial direction of the stator 1. However, the present invention is not limited thereto. For instance, the groove-shaped recess 1b may be divided into recesses which may be mutually offset in the central axial direction at a part or a plurality of portions of the entire outer periphery of the stator 1.

The depth of the recess 1b may not be necessarily identical in all the stator tooth portions 2. Namely, in FIG. 3B, the bottom surface of the recess 1b is located at a constant distance from the base portions 2c of the stator tooth portions 2 toward the tip ends 2a, but the distance may be appropriately modified.

### Third Embodiment

The third embodiment will be described below. The same components as those in the first embodiment are assigned the same reference numerals and no explanation thereof will be given hereinafter. In particular, only the difference from the first embodiment will be described.

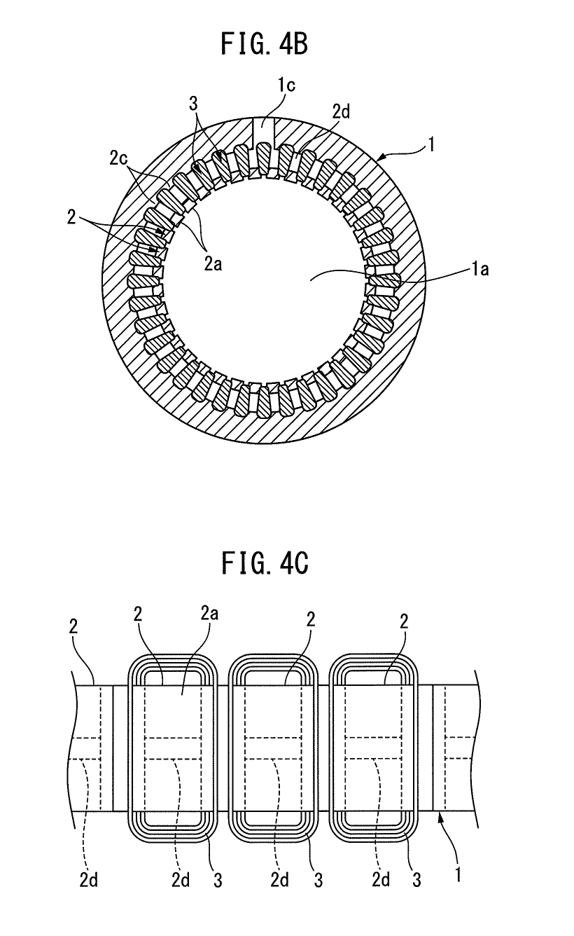

FIG. 4A is a schematic sectional view of a stator according to the third embodiment to illustrate how the coils are impregnated with varnish which is dropped thereon. FIG. 4B is a sectional view of a stator taken along the line D-D in FIG. 4A and FIG. 4C is a schematic view of a part of the inner peripheral portion of the stator shown in FIG. 4B.

In the third embodiment, a communication hole 2d in which varnish passes is formed in each of the stator tooth portions 2, as can be seen in FIGS. 4A to 4C. Furthermore, at least one recess 1c is formed in the outer peripheral portion of the stator 1 and is connected to the communication hole(s) 2d of any optional stator tooth portion(s) 2. With this arrangement, varnish can be introduced into the communication holes 2d from the recess 1c.

More specifically, the communication holes 2d are located in the intermediate portions between both ends of the stator tooth portions 2 in the direction of the central axis X, as can be seen in FIG. 4A. As shown in FIG. 4B, the plurality of communication holes 2d extend through the respective stator tooth portions 2 so that the communication holes 2d are successively arranged in the circumferential direction of the stator 1. The opposite ends of each communication hole 2d are located in proximity to the coils 3 as shown in FIG. 4C. Consequently, when varnish is dropped into the recess 1c formed in the outer periphery of the stator 1, the varnish can be supplied directly to the coils 3 through the communication holes 2d in the stator tooth portions 2, as shown in FIG. 4A. Namely, the communication holes 2d and the recess 1c define a varnish supply passage. The remaining structures are identical to those in the first embodiment.

Next, the method for impregnating the coils 3 of the stator 1 according to the third embodiment with varnish will be described below.

As shown in FIG. 4A, the stator 1 is placed so that the central axis X of the stator 1 extends in the horizontal direction and the stator 1 is supported so as to rotate about the central axis X. Tow nozzles 6 are inserted in the hollow portion 1a of the stator 1 through the openings of the housings 4 and 5 so as to drop varnish onto the coil ends 3a located at both ends of the stator tooth portions 2. Furthermore, an additional nozzle 7 is arranged outside of the stator 1 so as to drop varnish into the recess 1c formed in the outer periphery of the stator 1. Varnish is dropped from the two nozzles 6 and the additional nozzle 7. Note that, while the varnish is dropped, the stator 1 is rotated about the central axis X.

The varnish dropped onto each coil end 3a moves therefrom to the coil portions that are located at the intermediate portions between the opposite ends of the stator tooth portions 2 due to a capillary force produced between the adjacent windings of the coils 3. Furthermore, the varnish dropped into the recess 1c is supplied directly to the coils 3 through the communication holes 2d to impregnate the coils. Namely, the varnish can be supplied directly to the coil portions other than the coil ends 3a. Thus, even if the total length of the stator 1 in the direction of the central axis X is long, it is possible to sufficiently impregnate the entirety of the coils 3 with varnish. In particular, as shown in FIG. 4A, the recess 1c and the communication holes 2d are located in the intermediate portions between the opposite ends of the stator tooth, portions 2 in the direction of the central axis X. As a result of this arrangement, when varnish is dropped onto the coil ends 3a and into the recess 1c, it is possible to uniformly and effectively impregnate the coils 3 with the varnish in the direction of the central axis X of the stator 1.

As may be understood from the foregoing, according to the third embodiment, the rate of occurrence of the stators 1 whose coils 3 have failed to be sufficiently impregnated with the varnish can be reduced compared with the prior art shown in FIGS. 5A and 5B. Furthermore, the time necessary to impregnate the coils 3 with the varnish and the amount of varnish to be used can be reduced compared with the prior art. Consequently, the productivity of the motors can be improved.

Moreover, according to the third embodiment, the communication holes 2d in which varnish passes are formed in the stator tooth portions 2 and the recess 1c is formed in the outer peripheral portion of the stator 1, wherein the communication holes 2d are connected to the recess 1c. With this arrangement, the third embodiment has an advantage that it is not necessary to form the recess extending over the entire inner or outer periphery of the stator 1, compared with the first or second embodiment.

Alternatively, an additional recess(es) 1c and communication holes 2d may be formed in the portions other than the intermediate portions of the stator 1. As it is necessary for the recess 1c to be formed for at least one of the communication holes 2d, a plurality of recesses 1c may be formed in the outer peripheral portion of the stator 1.

Moreover, in the third embodiment, as shown in FIG. 4B, the recess 1c is formed in the outer peripheral portion of the stator 1, but the present invention is not limited thereto. For instance, the recess 1c into which varnish is dropped may be formed in the inner peripheral portion of the stator 1, and preferably in the tip ends of the stator tooth portions 2 and may be connected to the communication holes 2d.

Furthermore, in the third embodiment, as shown in

FIG. 4B, the plurality of communication holes 2d are successively formed to extend over the entire periphery of the stator 1 and are located at the same position in the central axial direction of the stator 1. However, the present invention is not limited thereto. For instance, at least one of the communication holes 2d may be arranged to be offset from the other communication holes in the central axial direction at a part or a plurality of portions of the entire periphery of the stator 1.

Furthermore, in FIG. 4B, the centers of the communication holes 2d are located at a constant distance from the base portions 2c of the stator tooth portions 2 toward the tip ends 2a thereof, but the distance may be appropriately modified to be different among the stator tooth portions. Furthermore, the inner diameter of each communication hole 2d may be appropriately modified.

Although the above description has been addressed to the embodiments in which the invention is applied to a stator for a rotating motor by way of example, the stator of the present invention is not limited to the application thereof to a rotating motor but can be applied to a linear motor.

Effect of the Invention

According to the first aspect of the present invention, as the varnish supply passage is used when varnish is dropped to impregnate the coil with the varnish, the varnish can be supplied directly to the coils through the inside of the stator tooth portions 2. By using such a varnish supply passage and dropping the varnish onto each coil end, the entirety of the coil can be sufficiently impregnated with the varnish even if the overall length of the stator is long. As a result, the rate of occurrence of the stators whose coils have failed to be sufficiently impregnated with varnish can be reduced compared with the prior art. Furthermore, the time necessary to impregnate the coil with the varnish and the amount of varnish to be used can be reduced compared with the prior art. Consequently, the productivity of the motors can be improved.

According to the second aspect of the present invention, the recesses formed to extend from the tip ends of the stator tooth portions toward the base portions thereof define the varnish supply passage, and accordingly, the varnish dropped into the recesses can easily reach the coil portions that are located in the vicinity of the base portions of the stator tooth portions.

According to the third aspect of the present invention, the same effect as the aforementioned second aspect can be brought about. Furthermore, if the stator is in the form of a cylinder whose inner peripheral portion constitutes the first side on which the tooth portions are formed, the recess of the third aspect is formed on the outer peripheral side of the stator. Consequently, the nozzles from which varnish is dropped are arranged outside of the stator. Therefore, compared with the second aspect, the third aspect has an advantage that it is not necessary for the plurality of nozzles from which varnish is dropped into the recess to be concentrated in the hollow portion of the stator.

According to the fourth aspect of the present invention, as the recesses are located in the intermediate portions between the opposite ends of the stator tooth portions in the longitudinal direction thereof, when varnish is dropped onto each coil end and into the recesses, the coil can be uniformly and effectively impregnated with the varnish in the longitudinal direction of the tooth portions.

According to the fifth aspect of the present invention, the varnish supply passage in which the varnish passes is formed in the tooth portions, and the recess is formed in either the first side portion or the second side portion of the stator, wherein the communication holes are connected to the recess. Therefore, compared with the second or third aspect, the fifth aspect has an advantage that it is not necessary to form a large recess in the surface of the stator.

According to the sixth aspect of the present invention, as the communication holes are arranged at the intermediate portions between the opposite ends of the tooth portions in the longitudinal direction, the same effect as the aforementioned fourth aspect can be obtained.

Note that the above description has been applied to the representative embodiments, but the present invention is not limited to the aforementioned embodiments and can be variously modified in the shape, structure or material, etc., without departing from the scope and spirit of the invention.

What is claimed is:

1. A stator for a motor comprising a first side and a second side opposite the first side, wherein
the stator comprises a plurality of tooth portions arranged on the first side, and
coils wound around the tooth portions,
the stator is provided with at least one varnish supply passage formed therein to supply varnish to the coils through the inside of the tooth portions.

2. The stator according to claim 1, wherein the varnish supply passage is formed by recesses formed to extend from tip ends of the tooth portions toward base portions thereof, so that the coils are exposed in the recesses.

3. The stator according to claim 1, wherein the varnish supply passage is formed of a recess formed in the second side, so that the coils are exposed in the recess.

4. The stator according to claim 2, wherein the recesses are located in intermediate portions between both ends of the tooth portions in the longitudinal direction.

5. The stator according to claim 1, wherein
the varnish supply passage comprises a recess formed on either the first side or the second side, and communication holes in which the varnish passes, connected to the recess and extending through the tooth portions,
both ends of the communication holes are located in proximity to the coils.

6. The stator according to claim 5, wherein the recess and the communication holes are located in intermediate portions between both ends of the tooth portions in the longitudinal direction.

7. The stator according to claim 1, wherein
the stator is cylindrical,
the first side is defined by the inner peripheral portion or outer peripheral portion of the cylindrical stator, and
the plurality of tooth portions are successively provided in the circumferential direction of the cylindrical stator.

8. A motor comprising the stator according to claim 1.
